(19) United States
(12) Patent Application Publication
(10) Pub. No.: US 2025/0081174 A1
(43) Pub. Date: Mar. 6, 2025

(54) TECHNIQUES FOR PERFORMING SCHEDULING IN WIRELESS COMMUNICATIONS

(71) Applicant: ZTE Corporation, Shenzhen (CN)

(72) Inventors: Jiajun XU, Shenzhen (CN); Mengzhu CHEN, Shenzhen (CN); Xiaoying MA, Shenzhen (CN); Hong TANG, Shenzhen (CN); Jianqiang DAI, Shenzhen (CN); Jun XU, Shenzhen (CN); Bo DAI, Shenzhen (CN)

(73) Assignee: ZTE Corporation, Shenzhen (CN)

(21) Appl. No.: 18/913,310

(22) Filed: Oct. 11, 2024

Related U.S. Application Data
(63) Continuation of application No. PCT/CN2022/108690, filed on Jul. 28, 2022.

(51) Int. Cl. H04W 72/11; H04L 5/00; H04W 72/232

(52) U.S. Cl. CPC H04W 72/11; H04L 5/0005; H04W 72/232

(57) ABSTRACT

Techniques are described to perform scheduling in wireless communications. An example wireless communication method includes receiving, by a communication device from a network device, a control signaling including one or more parameters of a semi-persistent scheduling (SPS) configuration for a scheduling of one or more time and frequency resources; and performing, by the communication device, an operation based on the SPS configuration, where the operation is performed according to an application delay.

### CROSS REFERENCE TO RELATED APPLICATIONS

This application is a continuation of International Patent Application No. PCT/CN2022/108690, filed on Jul. 28, 2022, the contents of which are incorporated herein by reference in their entirety.

### TECHNICAL FIELD

This document is directed generally to digital wireless communications.

### BACKGROUND

Mobile telecommunication technologies are moving the world toward an increasingly connected and networked society. In comparison with the existing wireless networks, next generation systems and wireless communication techniques will need to support a much wider range of use-case characteristics and provide a more complex and sophisticated range of access requirements and flexibilities.

Long-Term Evolution (LTE) is a standard for wireless communication for mobile devices and data terminals developed by 3rd Generation Partnership Project (3GPP). LTE Advanced (LTE-A) is a wireless communication standard that enhances the LTE standard. The 5th generation of wireless system, known as 5G, advances the LTE and LTE-A wireless standards and is committed to supporting higher data-rates, large number of connections, ultra-low latency, high reliability and other emerging business needs.

### SUMMARY

Techniques are disclosed for performing scheduling in wireless communications. For example, techniques are describe to control a timing related to a control signal for a scheduling technique (e.g., a semi-persistent scheduling (SPS) technique) and a resource (e.g., SPS resource). This patent document also describes configuration related to one or more time and frequency resources (also known as one or more SPS resources) or multiple sets of time and frequency resources (also known as SPS sets) for a scheduling technique.

A first example wireless communication method includes receiving, by a communication device from a network device, a control signaling including one or more parameters of a semi-persistent scheduling (SPS) configuration for a scheduling of one or more time and frequency resources; and performing, by the communication device, an operation based on the SPS configuration, where the operation is performed according to an application delay.

A second example wireless communication method includes transmitting, by a communication device to a network device, a control signaling including one or more parameters of a semi-persistent scheduling (SPS) configuration for a scheduling of one or more time and frequency resources; and performing, by the communication device, an operation based on the SPS configuration, where the operation is performed according to an application delay.

A third example wireless communication method includes transmitting, by a network device to a communication device, a control signaling including one or more parameters of a semi-persistent scheduling (SPS) configuration for a scheduling of one or more time and frequency resources; and transmitting or receiving, by the network device, on the one or more time and frequency resources based on the SPS configuration and according to an application delay.

A fourth example wireless communication method includes receiving, by a network device from a communication device, a control signaling including one or more parameters of a semi-persistent scheduling (SPS) configuration for a scheduling of one or more time and frequency resources; and transmitting or receiving, by the network device, on the one or more time and frequency resources based on the SPS configuration and according to an application delay.

In some embodiments, the SPS configuration includes any one or more of: a periodicity information, one or more SPS configuration indices, one or more time and frequency resources, one or more time and frequency resource groups, a length information of a duration, a valid or invalid indication, and/or an offset information. In some embodiments, each of the one or more time and frequency resource groups include a set of time and frequency resources, the set of one or more time and frequency resources are associated with a length information of a duration and a valid or invalid indication, the length information of the duration indicates a time range for the set of one or more time and frequency resources, and the valid or invalid indication indicates a time domain location of the set of one or more time and frequency resources. In some embodiments, each of the one or more time and frequency resources group is associated with a plurality of SPS configuration indices and an offset information, and the offset information indicates an offset between a set of one or more time and frequency resources with different SPS configuration indices.

In some embodiments, the control signaling includes any one or more of: Radio Resource Control (RRC) signaling, Medium Access Control Control Element (MAC CE) signaling, Downlink Control Information (DCI) signaling, or Uplink Control information (UCI) signaling. In some embodiments, the one or more parameters of the SPS configuration in the DCI signaling includes one or more types of indications that includes: an activation indication for the one or more time and frequency resources, a release indication for the one or more time and frequency resources, and/or an update indication and updated parameters for the one or more time and frequency resources. In some embodiments, the one or more parameters of the SPS configuration in DCI signaling includes an activation indication that indicates that at least one time and frequency resource is used for transmitting or receiving data. In some embodiments, the one or more parameters of the SPS configuration in DCI signaling includes a release indication that indicates that at least one time and frequency resource is not used for transmitting or receiving data.

In some embodiments, the one or more parameters of the SPS configuration in DCI signaling includes an update indication that indicates that at least one parameter of the SPS configuration is updated by information included in the control signaling. In some embodiments, the updated parameters of the SPS configuration includes any one or more of: a Modulation and Coding Scheme (MCS) level, an information for MCS table, a time domain resource assignment (TDRA), a frequency domain resource assignment (FDRA), a number of layers, a periodicity information, a valid or invalid indication, and/or an offset information. In some embodiments, the one or more types of indication is determined or indicated by any one or more of: high layer parameters, a DCI format, a DCI field including, a HARQ Process Number, a Redundancy Version, a Time domain resource assignment, a Frequency domain resource assignment, a MCS, a Downlink assignment index, a TPC command for scheduled PUCCH, and/or a VRB-to-PRB mapping.

In some embodiments, the one or more parameters of the SPS configuration in the UCI signaling includes any one or more of: an activation indication for the one or more time and frequency resources, and/or a release indication for the one or more time and frequency resources. In some embodiments, the one or more parameters of the SPS configuration in UCI signaling includes the activation indication that indicates that at least one time and frequency resource is used for transmitting or receiving data. In some embodiments, the one or more parameters of the SPS configuration in UCI signaling includes the release indication that indicates that at least one time and frequency resource is not used for transmitting or receiving data. In some embodiments, the operation based on SPS configuration includes any one of: transmitting in the one or more time and frequency resources, receiving in the one or more time and frequency domain resources, determining not to transmit in the one or more time and frequency resources, or determining not to receive in one or more time and frequency domain resources. In some embodiments, the application delay is determined by any one or more of: a starting time point; an ending time point; a distance between the starting time point and the ending time point.

In some embodiments, the starting time point includes at least one of the following: a slot of Physical Downlink Control Channel (PDCCH) monitoring; a last symbol of PDCCH monitoring; a slot for UCI transmission; a last symbol of Physical Uplink Control Channel (PUCCH) transmitting UCI; a last symbol of Physical Uplink Shared Channel (PUSCH) transmitting UCI; a slot of the first resource in the one or more time and frequency resources; a first symbol of the one or more time and frequency resources; a last symbol of one or more time and frequency resource. In some embodiments, the ending time point includes at least one of the following: a slot of the one or more time and frequency resources; a last symbol of the one or more time and frequency resources; a slot of UCI transmission; a first symbol of PUCCH transmitting UCI; a first symbol of PUSCH transmitting UCI, a slot of PDCCH monitoring; a first symbol of PDCCH monitoring. In some embodiments, the slot of the one or more time and frequency resources includes a slot of the first resource within the one or more time and frequency resource, a slot of the first resource within the time and frequency resource group, a slot of the last resource within the one or more time and frequency resources, or a slot of the last resource within the time and frequency resource group.

In some embodiments, the first or last symbol of the one or more time and frequency resources includes the first or last symbol of the first resource within the one or more time and frequency resources, the first or last symbol of the first resource within the time and frequency resource group, the first or last symbols of the last resource within the one or more time and frequency resources, the first or last symbols of the last resource within the time and frequency resource group. In some embodiments, a distance K between the starting time point and the ending time point is determined or indicated by at least one of: a high layer parameter; a subcarrier spacing; a User Equipment (UE) capability, where the distance K is a positive integer in symbol, slot or millisecond. In some embodiments, in the distance K, any one or more of the following operations is performed: another control signaling is not transmitted in the distance K; another control signaling are not transmitted in the same slot of the control signaling; another control signaling are expired when they are transmitted in the distance K; or another control signaling replace the control signaling when they are transmitted in the distance K. In some embodiments, the application delay includes the slot or the last symbol of PDCCH monitoring as the starting time point, the slot or the first symbol of the first resource within the time and frequency resource group as the ending time point and distance K slots or symbols between the slot or the last symbol of PDCCH monitoring and the slot or the first symbol of the first resource, when the control signaling is received in an n-th slot or symbol, the operation is performed at the slot of the first resource within the time and frequency resource group located at an (n+K)-th slot or symbol, and where n and K are integers greater than or equal to one.

In some embodiments, the application delay includes the slot or the last symbol of PDCCH monitoring as the starting time point, the slot or the first symbol of the PDCCH monitoring or the UCI transmission as the ending time point, and distance K slots or symbols between the slot or the last symbols of PDCCH monitoring and the slot or the first symbol of PDCCH monitoring or the UCI transmission, when the control signaling is received in an n-th slot or symbol, the operation is performed at the time and frequency resource located at an (n+K)-th slot or symbol in response to the communication device by DCI or UCI, and where n and K are integers greater than or equal to one. In some embodiments, the application delay includes the slot or the first symbol of the PDCCH monitoring or the UCI transmission as the starting time point, the slot or the last symbol of PDCCH monitoring as the starting time point, and distance K slots or symbols between the slot or the first symbol of PDCCH monitoring or the UCI transmission and the slot or the last symbols of PDCCH monitoring, when the operation is performed at the time and frequency resource located at an n-th slot or symbol in response to the communication device by DCI or UCI, the control signaling is received in an (n−K)-th slot or symbol, or before an (n−K)-th slot or symbol, where n and K are integers greater than or equal to one, and where K is less than n.

In some embodiments, the application delay includes the slot or the first symbol of the first resource within the time and frequency domain resource group as the starting time point, the slot or the last symbol of PDCCH monitoring as the ending time point, and the distance K slots or symbols between the slot or the first symbol of the first resource and the slot or the last symbol of PDCCH monitoring, when the operation is performed at the first resource within the time and frequency resource group located at an n-slot or symbol, the control signaling is received in an (n−K)-th slot or symbol, or before an (n−K)-th slot or symbol and where n and K are integers greater than or equal to one. In some embodiments, the application delay includes the slot or the first symbol of the UCI transmission as the starting time point, the slot or the first symbol of the first resource within the time and frequency resource group as the ending time point, and the distance K slots or symbols between the slot or the first symbol of the UCI transmission and the slot or the last symbol of the first resource, when the control signaling is transmitting in an n-th slot or symbol, the operation is performed at the time and frequency resource located within the time ranging from (n−K)-th slot or symbol to (n)-th slot or symbol and where n and K are integers greater than or equal to one. In some embodiments, the SPS includes a configured grant (CG).

In yet another exemplary aspect, the above-described methods are embodied in the form of processor-executable code and stored in a non-transitory computer-readable storage medium. The code included in the computer readable storage medium when executed by a processor, causes the processor to implement the methods described in this patent document.

In yet another exemplary embodiment, a device that is configured or operable to perform the above-described methods is disclosed.

The above and other aspects and their implementations are described in greater detail in the drawings, the descriptions, and the claims.

### BRIEF DESCRIPTION OF THE DRAWING

FIGS. 1A-1B shows timelines for current semi-persistent scheduling (SPS) and current configured grant (CG) transmission.

FIG. 2 shows configurations for current SPS or current CG.

FIG. 3 shows multiple SPS physical downlink shared channels (PDSCHs) configurations or multiple CG physical uplink shared channels (PUSCHs) configurations with adaptive parameter adjustment.

FIG. 4 shows a timeline from control signaling to SPS resource.

FIG. 5 shows a timeline from control signaling to control signaling.

FIG. 6 shows a timeline from resource to control signaling.

FIG. 7 shows that when the control signaling is for one SPS configurations activation, the application delay can include a starting time point, an ending time point, and/or a distance N1.

FIG. 8 shows that when the control signaling is for one or more SPS configurations simultaneous deactivation, the application delay can include a starting time point, an ending time point, and/or a distance N1.

FIG. 9 shows that when the control signaling is for SPS parameters update, the application delay can include a starting time point, an ending time point, and/or a distance N1.

FIG. 10 shows that when the control signaling is for resource activation and release of one or more SPS, the application delay can include a starting time point, an ending time point, and/or a distance N1.

FIG. 11 shows that when control signaling is uplink control information (UCI) for activation or release of CG physical uplink shared channels (PUSCHs) in the CG PUSCH group, the application delay for deactivation UCI can include a starting time point, an ending time point, and/or a distance N1, while the application delay for activation UCI can include a starting time point, an ending time point and/or a distance N1′.

FIG. 12 shows the current SPS or CG configuration, implying that a 1^{st} time and frequency resource can transmit or receive data in the M-th slot, while a 2^{nd} time and frequency resource can transmit or receive data in the (M+10)-th slot according to the periodicity information.

FIG. 13 shows how to utilize a length information of a duration as well as an valid or invalid indication to configure a multiple SPS PDSCH/CG PUSCH configuration and what is the time and frequency resource group (e.g., SPS PDSCH/CG PUSCH group).

FIG. 14 shows how to utilize a plurality of SPS configuration indices and an offset information to configure a multiple SPS PDSCH/CG PUSCH configuration and what is the time and frequency resource group (e.g., SPS PDSCH/CG PUSCH group).

FIG. 15 shows update DCI update the parameters for a time and frequency resource group (e.g., SPS PDSCH/CG PUSCH group).

FIG. 16 shows how a time and frequency resource group (e.g., SPS PDSCH group) feedback confirm UCI (e.g., HARQ-ACK information).

FIG. 17 shows how an activation UCI and/or a release UCI work in a time and frequency resource group (e.g., CG PUSCH group).

FIG. 18 shows an exemplary block diagram of a hardware platform that may be a part of a network device or a communication device.

FIG. 19 shows an example of wireless communication including a base station (BS) and user equipment (UE) based on some implementations of the disclosed technology.

FIG. 20A shows an exemplary flowchart for receiving a control signaling and performing an operation.

FIG. 20B shows an exemplary flowchart for transmitting a control signaling and performing an operation.

FIGS. 21A-21B show exemplary flowcharts for transmitting or receiving on one or more time and frequency resources.

FIG. 22 shows that other control signalings are not transmitted or received in the distance K.

FIG. 23 shows that other control signalings are expired in the distance K.

### DETAILED DESCRIPTION

In beyond 5G and 6G communication, one of promising services is characterized by quasi-periodicity (jitter impact), large and various data amount and stringent latency requirement, including e.g., extended reality (XR) service. In prior arts, granted transmission, including configured grant (CG) and semi-persistent scheduling (SPS), is capable of conveying periodic data by preconfigured resource without grant request and excessive power consumption. However, owing to the service characteristic of quasi-periodicity as well as large and various data amount, current SPS and CG are not support to transmit this kind of service. To this end, multiple SPS configurations and multiple CG configurations with adaptive parameter adjustment should be considered for supporting the SPS/CG configuration to transmit XR traffic, where the adaptive parameter adjustment such as activation, deactivation, parameter update and resource quick grant and release, is determined by control signaling. This discourse aims to propose methods for how control signaling of adaptive parameters adjustment effect.

The example headings for the various sections below are used to facilitate the understanding of the disclosed subject matter and do not limit the scope of the claimed subject matter in any way. Accordingly, one or more features of one example section can be combined with one or more features of another example section. Furthermore, 5G terminology is used for the sake of clarity of explanation, but the techniques disclosed in the present document are not limited to 5G technology only, and may be used in wireless systems that implemented other protocols.

### I. Introduction

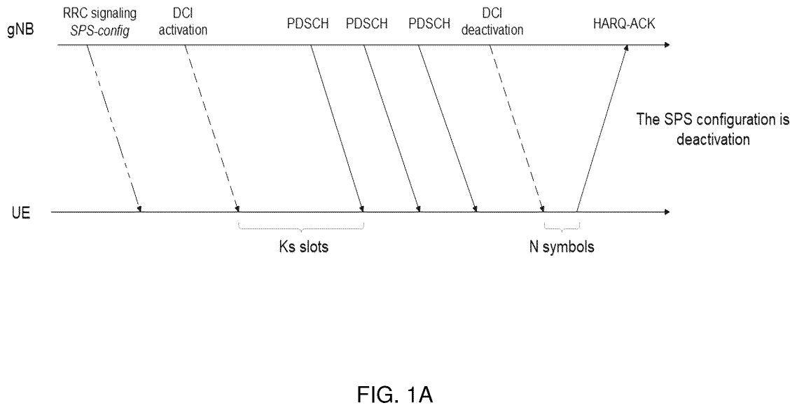

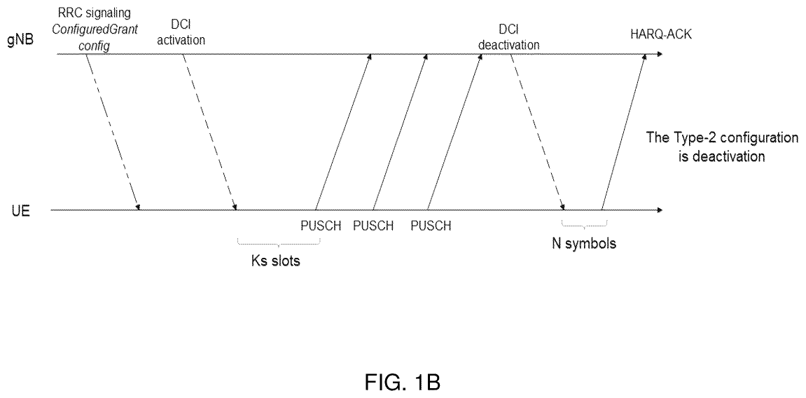

FIGS. 1A-1B shows timelines for current semi-persistent scheduling (SPS) and current configured grant (CG) transmission. For the SPS transmission or CG transmission, gNB first transmits a RRC signaling SPS-config or ConfiguredGrantConfig, respectively. Then, a DCI is used for activating the SPS transmission or CG transmission. Lastly, the SPS transmission or CG transmission is activated and the data would be transmitted in the preconfigured resources periodically. For SPS or CG transmission, the first SPS physical downlink shared channels (PDSCHs) is received or CG physical uplink shared channels (PUSCHs) is transmitted in K slots after UE receives the DCI with SPS or CG activation indication. While gNB is necessary to receive a HARQ-ACK information in order to confirm whether UE receives the deactivation indication. Considering the UE processing capability, the HARQ-ACK information for the deactivation indication is transmitted in N symbols after the deactivation indication reception.

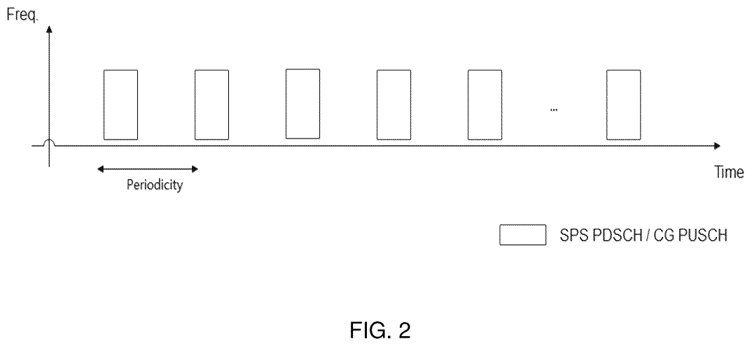

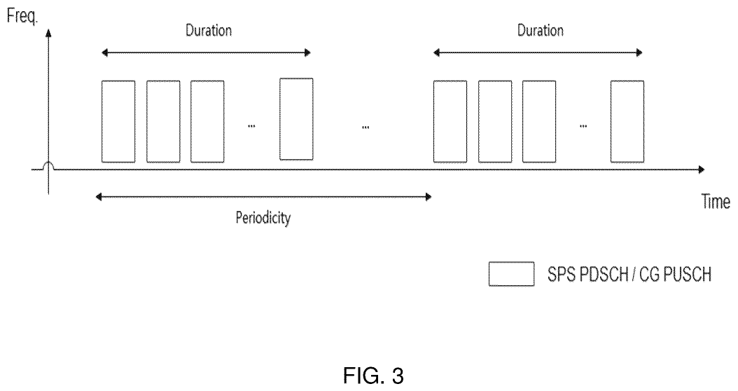

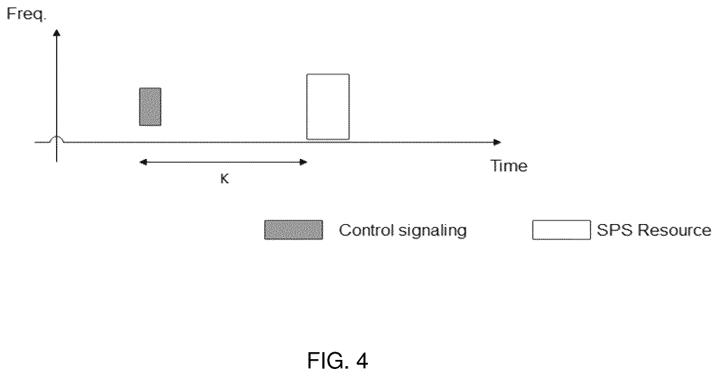

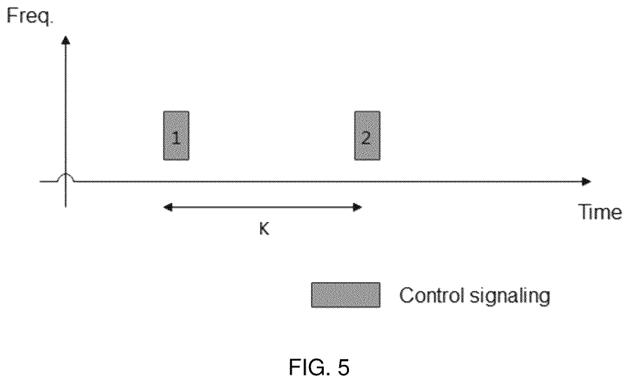

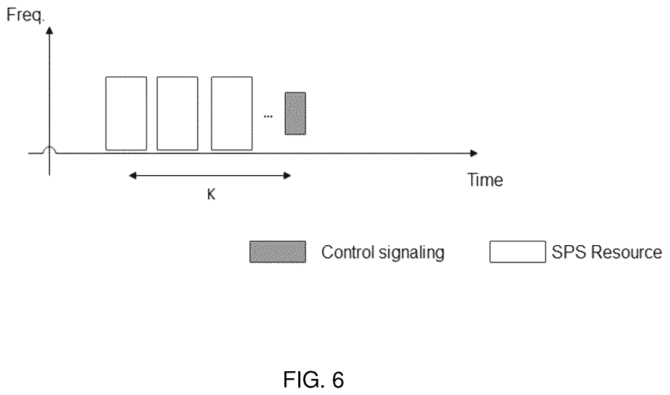

FIG. 2 shows configurations for current SPS or current CG. FIG. 3 shows multiple SPS PDSCHs configuration and multiple CG PUSCHs configurations with adaptive parameter adjustment. For the configurations in FIGS. 2-3, one or more control signalings may include parameters related to a configuration, where the parameters may be related to for activation, deactivation, parameter update, and so on, can have their own timeline. The control signalings may include radio resource control (RRC) signaling, a downlink control information (DCI) signaling and/or an UCI signaling. The timelines of the one or more control signalings may include the following cases (1) from control signaling to resource as shown in FIG. 4; (2) from control signaling to another control signaling as shown in FIG. 5; (3) from resource to control signaling as shown in FIG. 6.

In case (1) illustrated in FIG. 4, when a control signaling is transmitted or received in the n-th slot/symbol, the controlling signaling is valid for SPS resource in the (n+K)-th slot/symbol, or the UE performs a transmission or reception in a SPS resource in the (n+K)-th slot/symbol, or the UE performs an action in the (n+K)-th slot/symbol such as activation, deactivation or parameter update of an SPS resource. In this patent document, n and K are integers greater than or equal to one.

In case (2) illustrated in FIG. 5, when a first control signaling is transmitted in the n−th slot/symbol, the controlling signaling is valid for a SPS resource when a second control signaling (e.g., DCI or an acknowledgement indication such as HARQ-ACK) is received or transmitted in the (n+K)-th slot/symbol, then the UE performs a transmission or reception in a SPS resource after the (n+K)-th slot/symbol, or the UE performs an action after the (n+K)-th slot/symbol such as activation, deactivation or update of an SPS resource.

Alternatively, in case (2) illustrated in FIG. 5, when the second control signaling (e.g., DCI or an acknowledgement indication such as HARQ-ACK) is transmitted or received in the n−th slot/symbol, the first control signaling ought to be transmitted or received in (n−K)-th slot/symbol or before (n−K)-th slot/symbol.

In this patent document, an operation being associated with one or more slots/symbol can refer to operating a transmission or reception of uplink channel (e.g., PUSCH) or downlink channel (e.g., PDSCH), respectively, or not including performing an operation by UE such as activating/deactivating SPS resource(s). In case (3) illustrated in FIG. 6, when transmission configuration for SPS is associated with n-th, . . . (n+delta)-th, . . . (n+K−1)-th slot/symbol, respectively, the control signaling the controlling signaling is valid for SPS resource in the (n+K)-th slot/symbol, or the UE performs a transmission or reception in a SPS resource in the (n+K)-th slot/symbol, or the UE performs an action in the (n+K)-th slot/symbol such as activation, deactivation and confirmation of more than one SPS resource. In an example for case (3), the control signaling transmitted in (n+K)-th slot/symbol can be an acknowledgement indication such as HARQ-ACK that can be associated with or that can be used to indicate that data is received in SPS resources in n-th, . . . (n+delta)-th, . . . (n+K−1)-th slot/symbol.

Moreover, in the case illustrated in FIG. 4, when the operation is associated with the n-th slot/symbol, the control signaling ought to be transmitted or received in the (n−K)-th slot. For example, an uplink control information (UCI) used to activate/deactivate an SPS resource can be transmitted or received in the (n−K)-th slot when transmission/reception/an operation by UE is performed in an SPS resource in the n-th slot/symbol.

In this patent document the term SPS can refer to SPS configuration for downlink, or CG configuration for uplink. In this patent document the term SPS resource can refer to SPS PDSCH for downlink, or CG PUSCH for uplink, and the term time and frequency resource is similar to the term SPS resource. In this patent document, the term operation can refer to transmission, reception and so on.

This patent document describes techniques related to at least the following technical solutions:
The interpretation of a SPS configuration
The interpretation of a control signaling
The interpretation of an application delay.

### II. The Interpretation of a SPS Configuration

In some embodiments, the SPS configuration includes one SPS configuration index wherein the SPS configuration includes corresponds to any one or more of:

1. An information set for the SPS configuration index including any one or more of:
a. A periodicity information that indicates the time length between a time and frequency domain resource and its former and/or later time and frequency domain resource, or a time and frequency domain resource group and its former and/or later time and frequency domain resource group, wherein a time and frequency resource group includes one or more time and frequency resources.
b. A length information of a duration, where the length information indicates a time length associated with a time and frequency resource group allocated to a UE, where the time length can be less than or equal to a periodicity information as shown in FIGS. 2 and 3.
c. A valid or invalid indication that identifies one or more slots within the duration that is available for one or more time and frequency resources. In an example, a valid or invalid indication of time slots can be indicated using a bitmap.
d. An offset information that indicates a time offset between two nearby time and frequency resources within one time and frequency resource group.

2. A number of SPS resources

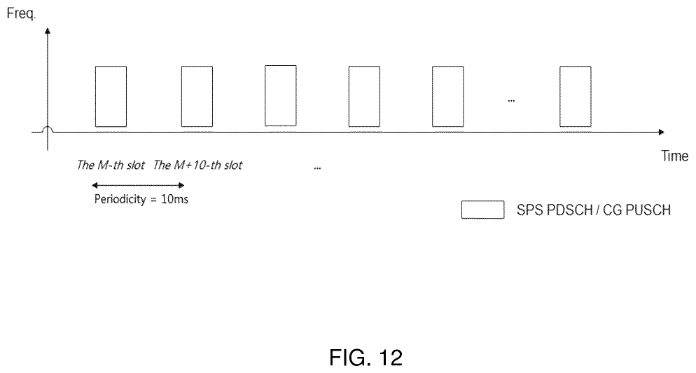

In one example, the SPS configuration includes one SPS configuration index, which corresponds to a periodicity information, i.e., periodicity in SPS-config or periodicity in ConfiguredGrantConfig, as ‘10 ms’ or ‘10 ms×14 symbols’, the SPS configuration is shown in FIG. 12.

In FIG. 12, the 1^{st} time and frequency resource is transmitted or received in the M-th slot, the 2^{nd} time and frequency resource is transmitted or received in the (M+10)-th slot, and so on.

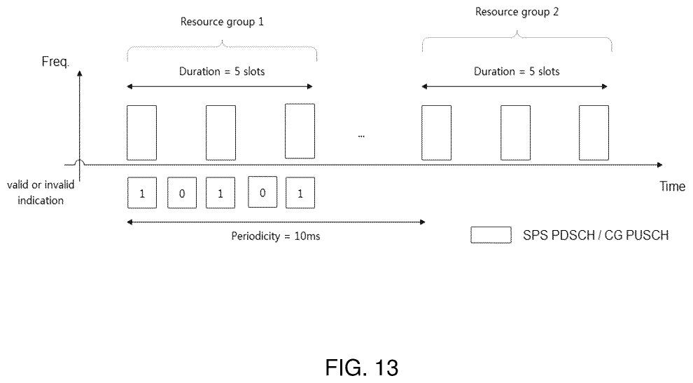

In another example, the SPS configuration includes one SPS configuration index, which corresponds to a periodicity information, i.e., periodicity in SPS-config or periodicity in ConfiguredGrantConfig, as ‘10 ms’ or ‘10 ms×14 symbols’, a length information of a duration as ‘5 slots’, a valid or invalid indication as a bitmap ‘10101’ the SPS configuration is shown in FIG. 13.

In FIG. 13, the first time and frequency resource group denoted as Resource group 1 includes from the 1^{st} time and frequency resource to the 3^{rd} time and frequency resource. The pattern is also achieved if the offset information is set to ‘1 slots’, which is similar to the valid or invalid indication setting as ‘10101’.

According to the above example, the time and frequency resource group is associated with the length information of the duration, the valid or invalid indication or the offset information.

In some embodiments, the SPS configuration includes a SPS set, wherein the SPS set includes any one or more of:

1. One or more SPS configuration indices

2. An information set for SPS set including any one or more of:
a. A periodicity information for different SPS configuration indices in the SPS set
b. An offset information for different SPS configuration indices in the SPS set
c. An amount information of SPS configuration indices.

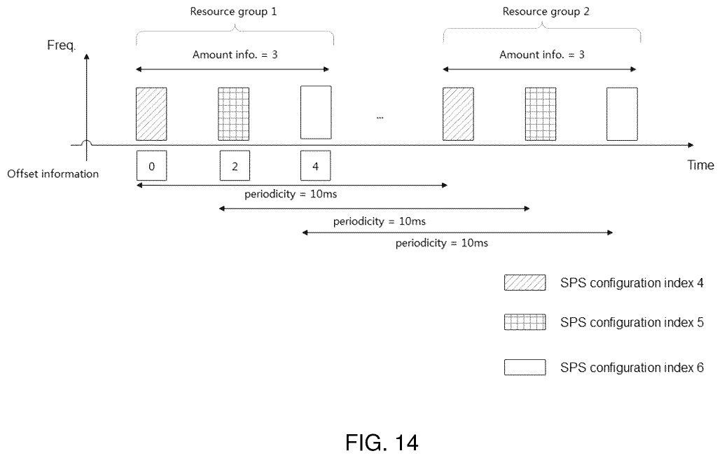

In one example, if the pattern in FIG. 13 is configured, the SPS set in SPS configuration includes three SPS configuration indices, e.g. {4, 5, 6}. As a result, the amount information or number of SPS configuration indices (as shown in FIG. 13) is set to ‘3’. The periodicity information for the three SPS configuration indices is set to ‘10 ms’, while the offset information for the SPS configuration indices from 4 to 6 is set to ‘0’, ‘2’, and ‘4’, respectively. The SPS configuration is shown in FIG. 14.

In FIG. 14, the pattern is similar with that of FIG. 13, but different with a SPS set configuration. There are a plurality of SPS sets, and gNB indicates one of the SPS set for configuring the corresponding pattern based on the amount information of SPS configuration indices.

According to the above example, the time and frequency resource group is associated with the amount information of SPS configuration indices, a plurality of SPS configuration indices, the offset information.

### III. The Interpretation of a Control Signaling

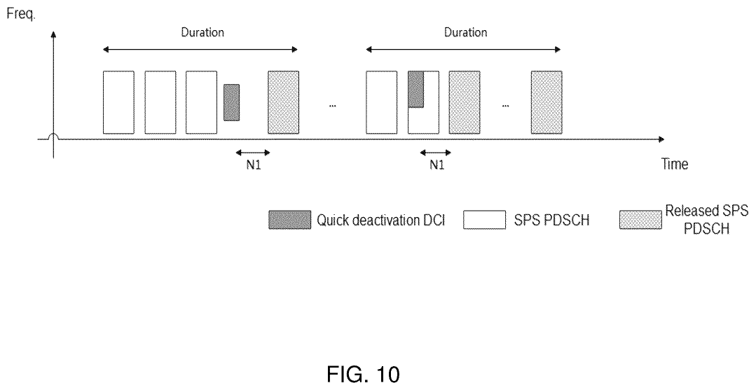

1. In some embodiments, the control signaling is high layer signaling, including:
   a. Radio resource control (RRC) signaling
   b. Medium access control control element (MAC CE) signaling
   In some cases, the high layer signaling is RRC signaling SPS-config, or ConfiguredGrantConfig. 1n this case, the SPS-config, or ConfiguredGrantConfig is for a SPS configuration activation.
   In some cases, the high layer signaling is MAC CE signaling Configured Grant Confirm, or multiple configured Grant Confirm.
2. In some embodiments, the control signaling is downlink control information (DCI) signaling
   In some cases, the DCI signaling is a UE-specific DCI or a group common DCI.
      For the UE-specific DCI, such as DCI format 0_0, DCI format 0_1, and DCI format 0_2 for uplink, or DCI format 10, DCI format 1_1, DCI format 1_2 for downlink, the parameters of the SPS configuration in DCI signaling includes different types of indications, wherein the types of indication are determined by high layer parameter, DCI format, different states of DCI field.
      For DCI containing different type of indications, the states of mentioned DCI field are different.
   A. In some cases, the DCI signaling is for SPS activation
      The parameters of the SPS configuration in the DCI signaling includes DCI fields to indicate the DCI signaling is for SPS activation.
      In some cases, the DCI field ‘HARQ Process Number’, ‘Redundancy version’ are set to all ‘1’ to indicate the DCI is for SPS activation.
      In some cases, the DCI fields ‘HARQ Process Number’, ‘Redundancy version’ are set to all ‘1’, while at least one of DCI fields like ‘Time domain resource assignment’; ‘Frequency domain resource assignment’; ‘MCS’; ‘Downlink assignment index’; ‘TPC command for scheduled PUCCH’; or ‘VRB-to-PRB mapping’, are re-interpreted to all ones or all zeros to indicate the SPS configuration in FIG. 13 activation.
      In some cases, the DCI field ‘Redundancy version’ is set to all ‘1’ and the DCI field ‘HARQ Process Number’ is re-interpreted to indicate SPS set index to indicate the DCI is for SPS configuration with a plurality of SPS configuration indices in FIG. 14 simultaneous activation.
      In some cases, one or more DCI fields such as ‘HARQ Process Number’, ‘Redundancy version’, ‘Time domain resource assignment’; ‘Frequency domain resource assignment’; ‘MCS’; ‘Downlink assignment index’; ‘TPC command for scheduled PUCCH’; or ‘VRB-to-PRB mapping’, are re-interpreted to all zeros or all ones to indicate the time and frequency resource in the time and frequency resource group is activated.
   B. In some cases, the DCI signaling is for SPS release
      The parameters of DCI signaling includes DCI fields to indicate the DCI signaling is for SPS release/deactivation.
      In some cases, the DCI fields such as ‘HARQ Process Number’, ‘Redundancy version’ and ‘Frequency domain assignment’ are set to all ones or all zeros to indicate the DCI signaling is for the SPS configuration release.
      In some cases, the DCI fields such as ‘Redundancy version’ and ‘Frequency domain assignment’ are set to all ones or all zeros, while ‘HARQ Process Number’ indicates the SPS configuration indices list to indicate the DCI signaling is for a plurality of SPS configuration indices release.
      In some cases, the DCI field such as ‘Redundancy version’ and ‘Frequency domain assignment’ is set to all ones or all zeros, while ‘HARQ Process Number’ indicates the SPS set including a plurality of SPS configuration indices to indicate the DCI signaling is for SPS configuration in FIG. 14 release.
      In some cases, the DCI fields such as ‘HARQ Process Number’, ‘Redundancy version’ and ‘Frequency domain assignment’ are set to all ones or all zeros, while one or more DCI fields, such as ‘Time domain assignment’, ‘Time domain resource assignment’; ‘Frequency domain resource assignment’; ‘MCS’; ‘Downlink assignment index’; ‘TPC command for scheduled PUCCH’; or ‘VRB-to-PRB mapping’, are re-interpreted to all ones or all zeros to indicate the DCI signaling is for the time and frequency resources release in the time and frequency domain resource group as illustrated in FIG. 10.
   C. In some cases, the DCI signaling is for SPS parameter update
      The parameters of DCI signaling includes DCI fields to indicate the DCI signaling is for SPS parameters update.
      In some cases, the DCI fields for update indication includes at least one of: ‘HARQ Process Number’, ‘Redundancy Version’; ‘Downlink assignment index’; ‘TPC command for scheduled PUCCH’; or ‘VRB-to-PRB mapping’. One or more of these fields are re-interpreted to an update indication with P bits, where P is a positive integer. For example, the LSB of ‘HARQ Process Number’ is an update indication when ‘Redundancy version’ is set to all ones and the length information of the duration, the valid or invalid indication or the offset information are configured. The update indication is set to ‘1’, implying the DCI is for SPS parameter update, while the update indication is set to ‘0’, implying the DCI is not for SPS parameter update. The state of DCI fields for SPS parameter update are different from that of DCI field of SPS activation
         In this cases, the SPS parameter includes any one or more of:
         1. A modulation and coding scheme (MCS) level
         2. An information for MCS table
         3. A time domain resource assignment (TDRA)
         4. A frequency domain resource assignment (FDRA)
         5. A number of layers
         6. A periodicity information
         7. A valid or invalid indication
         8. An offset information
      The update parameters are valid in one or more time and frequency resource groups.

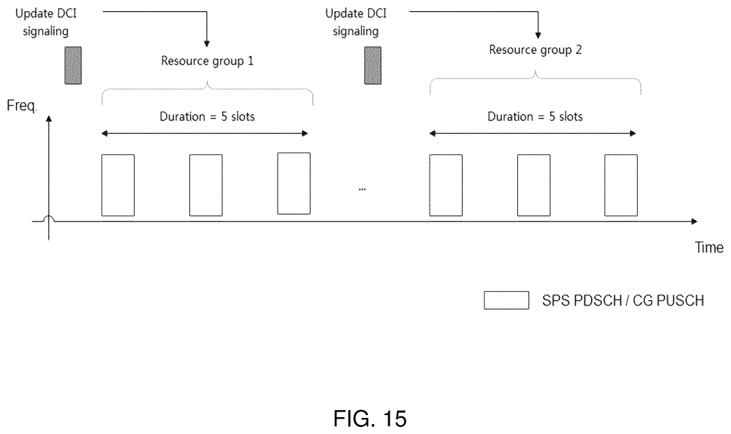

For example, as shown in FIG. 15, the update DCI signaling update the parameters mentioned above for the time and frequency resources in one time and frequency resource group.

For the group common DCI, such as DCI format 26, or a new defined DCI format 2, the parameters of the SPS configuration in DCI signaling determines different types of indication by specific defined fields.

A. In some cases, the DCI signaling is for SPS activation or for SPS deactivation/release
The parameters of DCI signaling include new defined DCI fields to indicate the DCI signaling is for SPS activation. The new defined field for indicating the time and frequency resource in the time and frequency resource group is activated or deactivation is ‘activation/release indication’ with one-bit length. When the field is indicated by ‘1’, implying the time and frequency resources in the time and frequency resource group is activation, while the field is indicated by ‘0’, implying the time and frequency resources in the time and frequency resource group is released/deactivation.

B. In some cases, the DCI signaling is for SPS parameter update
The parameters of DCI signaling includes new defined DCI fields to indicate the DCI signaling is for SPS parameters update. The new defined field for indicating the DCI signaling is for SPS parameter update. The other defined fields are indicating the update parameter such as, MCS level; an information for MCS table; a time domain resource assignment (TDRA); A frequency domain resource assignment (FDRA); A number of layers; A periodicity information; A valid or invalid indication; an offset information
   In some embodiments, the control signaling is uplink control information (UCI) signaling including at least one of (or any one or more of) a confirm indication, activation indication or deactivation indication.

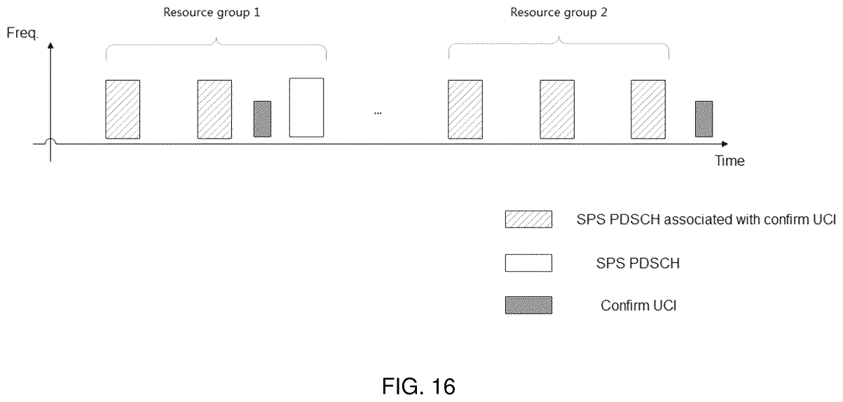

The following example is based on FIG. 16.

In an example for the confirm indication, the UCI signaling is a HARQ-ACK information for one or more time and frequency resources in a time and frequency resource group. In FIG. 16, the first HARQ-ACK information is associated with the first two CG PUSCHs in the Resource group 1, while the second HARQ-ACK information is associated with all the CG PUSCHs in the Resource group 2, wherein the time and frequency resource group is represented by Resource group and the time and frequency resource is represented by CG PUSCH.

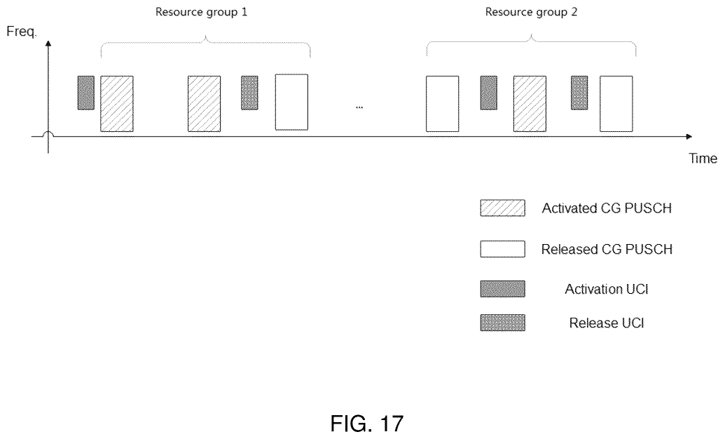

The following example is based on FIG. 17. In the FIG. 17, for the activation or deactivation/release indication, the first activation UCI activates the first two CG PUSCHs in Resource group 1, and when UE receives the first release UCI, the third CG PUSCH is released. While the second activation UCI activates the second CG PUSCH, and when UE does not receive the second activation UCI as well as UE receives the second release UCI, the first CG PUSCH and the third CG PUSCH are released in Resource group 2, respectively, wherein the time and frequency resource group is represented by Resource group and the time and frequency resource is represented by CG PUSCH.

For one example, UCI signaling is a scheduling request (SR) to indicate activation, implying one or more time and frequency resources in a time and frequency resource group are used for data transmission.

For one example, UCI signaling is a scheduling request (SR) to indicate deactivation/release, implying one or more time and frequency resources in a time and frequency resource group are not used for data transmission

For one example, UCI signaling is a new defined signaling, which is rather than a HARQ-ACK information, scheduling request, CSI report and carries the information of activation indication and deactivation/release indication. In some cases, there is an one-bit length information in the new defined signaling, wherein bit ‘1’ indicates activation, implying one or more time and frequency resources in a time and frequency resource group are used for data transmission, while bit ‘0’ indicates deactivation, implying one or more time and frequency resources in a time and frequency group are not used for data transmission.

### IV. The interpretation of an application delay

In some embodiments, the application delay is determined by at least one of (or any one or more of):
1. A starting time point
   a. In some cases, the starting time point includes any one or more of:
      i. A slot of PDCCH monitoring.
      ii. A last symbol of PDCCH monitoring.
      iii. A slot of UCI transmission.
      iv. A last symbol of UCI transmission in PUCCH.
      v. A last symbol of UCI transmission in PUSCH.
      vi. A slot of SPS resource
      vii. A last symbol of SPS resource
2. An ending time point
   i. A slot of the time and frequency resource determined by the control signaling
      1. In some cases, the time and frequency resource is the first time and frequency resource in the time and frequency resource group.
      2. In some cases, the time and frequency resource is the last time and frequency resource in the time and frequency resource group.
      3. In some cases, the time and frequency resource is the first time and frequency resource corresponding to the first SPS configuration indices in the SPS set.
      4. In some cases, the time and frequency resource is the time and frequency resource of the last SPS configuration indices in the SPS set.
   ii. A last symbol of the time and frequency resource determined by the control signaling
      5. In some cases, the time and frequency resource is the first time and frequency resource in the time and frequency resource group.
      6. In some cases, the time and frequency resource is the last time and frequency resource in the time and frequency resource group.
      7. In some cases, the time and frequency resource is the first time and frequency resource of the first SPS configuration index in the SPS set.
      8. In some cases, the time and frequency resource is the time and frequency resource of the last SPS configuration index in the SPS set.
   iii. A slot of UCI transmission
   iv. A first symbol of UCI transmission in PUCCH
   v. A first symbol of UCI transmission in PUSCH
   vi. A slot of PDCCH monitoring
   vii. A first symbol of PDCCH monitoring
3. A distance K between the start time point and the ending time point, where the K is an integer which is not less than 0, where the feature of K includes any one or more of the following:
   i. In some cases, the distance is determined by a high layer signaling.
   ii. In some cases, the distance is associated with sub-carrier spacing.
   iii. In some cases, the K is in slot or in symbol.
   iv. In some cases, K determined by UE capability
   v. In some cases, K is not less than K0min or K2 min, wherein K0min and K2 min is determined by a high layer signaling.
      a. In some cases, K0min is the minimumSchedulingOffsetK0 in RRC signaling PDSCH-Config
      b. In some cases, K2 min is the minimumSchedulingOffsetK2 in RRC signaling PUSCH-Config

The control signaling the controlling signaling is valid for time and frequency resource according to or based on the application delay, or the UE performs a transmission or reception in a time and frequency resource according to or based on the application delay, or the UE performs an action in a time and frequency resource according to or based on an application delay.

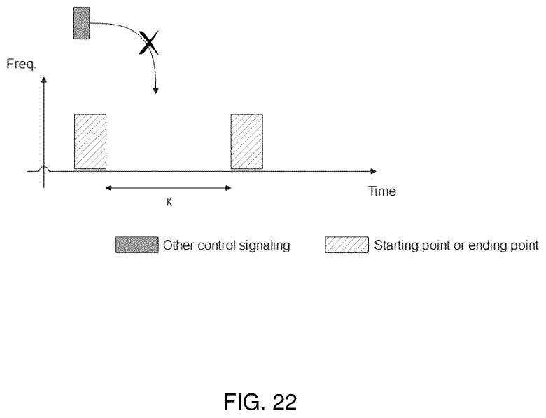

In some embodiments, other control signalings are not transmitted or received (or are determined not to be transmitted or received) in the distance K as illustrated in FIG. 22.

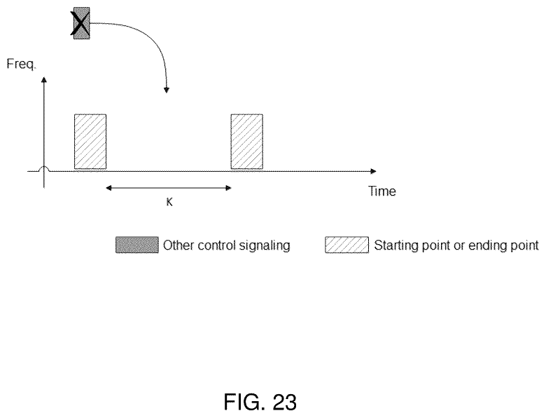

In some embodiments, other control signalings are expired in the distance K as illustrated in FIG. 23.

In some embodiments, the control signaling is replaced by the other same type control signaling transmitting in the distance K.

In some embodiments, other control signalings are not transmitted (or are determined not to be transmitted) in the same slot as the control signaling.

In the following examples, different application delays are shown.

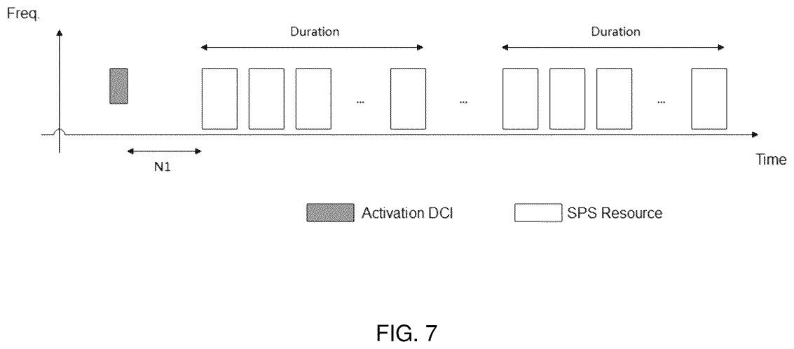

Example 1: FIG. 7 shows that when the control signaling is DCI signaling for SPS configuration activation, in one example, the application delay includes:
The starting time point: a slot of PDCCH monitoring
The ending time point: a slot of the first SPS PDSCH in the SPS PDSCH group (or starting time point is a slot of the first SPS PDSCH, while the ending point is a slot of PDCCH monitoring)
A distance: N₁ slots
   Assuming the DCI signaling for the downlink SPS configuration activation is received at the n-th slot, the slot of the first SPS PDSCH transmission is at

$$⌊ n \times \frac{{2}^{u , P D S C H}}{{2}^{u , PDCCH}} ⌋ + {N}_{1}$$

where n denotes the slot for PDCCH monitoring, u denotes the subcarrier spacing (SCS). In one example, the application delay includes:
The start time point: a last symbol of PDCCH monitoring
The ending time point: a first symbol of the first SPS PDSCH in the SPS PDSCH group. (or starting time point is the first symbol of the first SPS PDSCH in SPS PDSCH group, while the ending point is a last symbol of PDCCH monitoring)
A distance: N₁ symbols
   Assuming the DCI signaling for downlink SPS configuration activation is received at the n-th symbol, the first symbol of the first SPS PDSCH transmission is at

$$⌊ {n}_{slot} \times \frac{{2}^{u , PDSCH}}{{2}^{u , PDCCH}} \times {N}_{slot}^{s y m b o l} ⌋ + n + {N}_{1}$$

Where nₛₗₒₜ denotes the slot for PDCCH monitoring, Nₛₗₒₜ^{symbol} denotes the number of symbols in slot.
In one example, the application delay includes:
The starting time point: a slot of PDCCH monitoring
The ending time point: a slot of the first CG PUSCH in the CG PUSCH group (or starting time point is a slot of the first CG PUSCH, while the ending point is a slot of PDCCH monitoring)
A distance: N₁ slots
   Assuming the DCI signaling for the uplink SPS configuration activation is received at the n-th slot, the slot of the first CG PUSCH transmission is at

$$⌊ n \times \frac{{2}^{u , P D S C H}}{{2}^{u , PDCCH}} ⌋ + {N}_{1}$$

where n denotes the slot for PDCCH monitoring, u denotes the subcarrier spacing (SCS).

In another example, the application delay includes:
The start time point: a last symbol of PDCCH monitoring
The ending time point: a first symbol of the first CG PUSCH in the CG PUSCH group. (or starting time point is the first symbol of the first CG PUSCH in CG PUSCH group, while the ending point is a last symbol of PDCCH monitoring)
A distance: N₁ symbols
   Assuming the DCI signaling for uplink SPS configuration activation is received at the n-th symbol, the first symbol of the first SPS PDSCH transmission is at

$$⌊ {n}_{slot} \times \frac{{2}^{u , PDSCH}}{{2}^{u , PDCCH}} \times {N}_{slot}^{s y m b o l} ⌋ + n + {N}_{1}$$

Where nₛₗₒₜ denotes the slot for PDCCH monitoring, Nₛₗₒₜ^{symbol} denotes the number of symbols in slot.

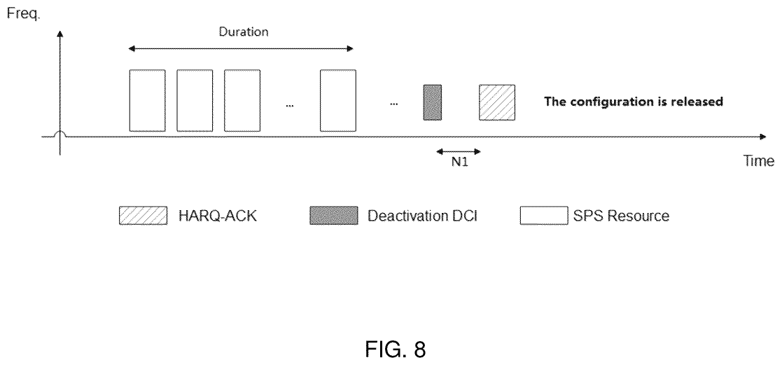

Example 2: FIG. 8 shows that when the control signaling is for SPS configuration deactivation, in one example, the application delay includes:
The starting time point: a slot of the HARQ-ACK information
The ending time point: a slot of PDCCH monitoring (or, the starting time point is a slot of PDCCH monitoring, while the ending time point is a slot of the HARQ-ACK information)
A distance: N₁ slots
   Assuming the HARQ-ACK information is transmitted in the n-th slot, the slot of the PDCCH monitoring is at or before

$$⌊ n \times \frac{{2}^{u , PUCCH}}{{2}^{u , PDCCH}} ⌋ - {N}_{1} or ⌊ n \times \frac{{2}^{u , PUSCH}}{{2}^{u , PDCCH}} ⌋ - {N}_{1}$$

where n denotes the slot for PDCCH monitoring, u denotes the subcarrier spacing (SCS).
in another example, the application delay includes:
The starting time point: a first symbol of the HARQ-ACK information
The ending time point: a last symbol of PDCCH monitoring (or, the starting time point is a last symbol of PDCCH monitoring, while the ending time point is a first symbol of the HARQ-ACK information)
A distance: N₁ symbols
   Assuming the HARQ-ACK information is transmitted in the n-th symbol, the slot of the PDCCH monitoring is at or before

$$⌊ {n}_{s l o t} \times \frac{{2}^{u , PUCCH}}{{2}^{u , PDCCH}} \times {N}_{s l o t}^{s y m b o l} ⌋ + n - {N}_{1} or$$

$$⌊ {n}_{s l o t} \times \frac{{2}^{u , PUSCH}}{{2}^{u , PDCCH}} \times {N}_{s l o t}^{s y m b o l} ⌋ + n - {N}_{1}$$

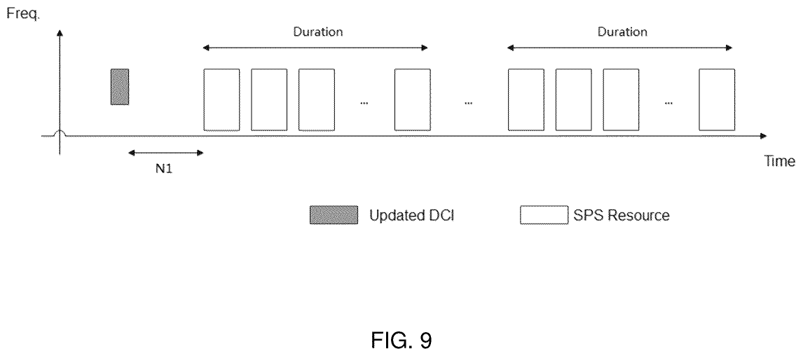

Example 3: FIG. 9 shows that when the control signaling is DCI signaling for SPS parameters update, in one example, the application delay includes:
The starting time point: a slot of the first SPS PDSCH in the SPS PDSCH group
The ending time point: a slot of PDCCH monitoring (or, the starting time point is a slot of PDCCH monitoring, while the ending time point a slot of the first SPS PDSCH in the SPS PDSCH group)
A distance: N₁ slots
   Assuming the slot of first SPS PDSCH in SPS PDSCH group for update is at the n-th slot, the slot of the DCI signaling for SPS parameters update is at or before

$$⌊ n \times \frac{{2}^{u , P D S C H}}{{2}^{u , PDCCH}} ⌋ - {N}_{1}$$

In one example, the application delay includes:
The starting time point: a first symbol of the first SPS PDSCH in the SPS PDSCH group
The ending time point: a last symbol of PDCCH monitoring (or, the starting time point is a last symbol of PDCCH monitoring, while the ending time point a first symbol of the first SPS PDSCH in the SPS PDSCH group)
A distance: N₁ symbols
   Assuming the symbol of first SPS PDSCH in SPS PDSCH group for update is at the n-th symbol, the last symbol of the DCI signaling for SPS parameters update is at or before

$$⌊ {n}_{slot} \times \frac{{2}^{u , PDSCH}}{{2}^{u , PDCCH}} \times {N}_{slot}^{s y m b o l} ⌋ + n - {N}_{1}$$

In one example, the application delay includes:
The starting time point: a slot of the first CG PUSCH in the CG PUSCH group
The ending time point: a slot of PDCCH monitoring (or, the starting time point is a slot of PDCCH monitoring, while the ending time point a slot of the first CG PUSCH in the CG PUSCH group)
A distance: N₁ slots
   Assuming the slot of first CG PUSCH in CG PUSCH group for update is at the n-th slot, the slot of the DCI signaling for SPS parameters update is at or before

$$⌊ n \times \frac{{2}^{u , P D S C H}}{{2}^{u , PDCCH}} ⌋ - {N}_{1}$$

In other example, the application delay includes:
The starting time point: a first symbol of the first CG PUSCH in the CG PUSCH group
The ending time point: a last symbol of PDCCH monitoring (or, the starting time point is a last symbol of PDCCH monitoring, while the ending time point a first symbol of the first CG PUSCH in the CG PUSCH group)
A distance: N₁ symbols
   Assuming the symbol of first CG PUSCH in CG PUSCH group for update is at the n-th symbol, the last symbol of the DCI signaling for SPS parameters update is at or before

$$⌊ {n}_{slot} \times \frac{{2}^{u , PDSCH}}{{2}^{u , PDCCH}} \times {N}_{slot}^{s y m b o l} ⌋ + n - {N}_{1}$$

Example 4: FIG. 10 shows that when the control signaling is DCI signaling for activation or release of SPS PDSCHs in the SPS PDSCH group, in one example, the application delay includes:
The starting time point: a slot of the first activated/released SPS PDSCH in the SPS PDSCH group
The ending time point: a slot of PDCCH monitoring (or, the starting time point is a slot of PDCCH monitoring, while the ending time point is a slot of the first released SPS PDSCH in the SPS PDSCH group)
A distance: N₁ slots
   Assuming the slot of the first activated/released SPS PDSCH in the SPS PDSCH group is at the n−slot, the slot of the DCI signaling for activation or release SPS PDSCHs in the SPS PDSCH group is at or before,

$$⌊ n \times \frac{{2}^{u , P D S C H}}{{2}^{u , PDCCH}} ⌋ - {N}_{1}$$

where n denotes the slot for control signaling transmission, u denotes the SCS.
In another example, the application delay includes:
The starting time point: a first symbol of the first activated/released SPS PDSCH in the SPS PDSCH group
The ending time point: a last symbol of PDCCH monitoring (or, the starting time point is a last symbol of PDCCH monitoring, while the ending time point is a first slot of the first released SPS PDSCH in the SPS PDSCH group)
A distance: N₁ symbols
   Assuming the symbol of the first activated/released SPS PDSCH in the SPS PDSCH group is at the n-th symbol, the slot of the DCI signaling for activation or release SPS PDSCHs in the SPS PDSCH group is at or before,

$$⌊ {n}_{slot} \times \frac{{2}^{u , PDSCH}}{{2}^{u , PDCCH}} \times {N}_{slot}^{s y m b o l} ⌋ + n - {N}_{1}$$

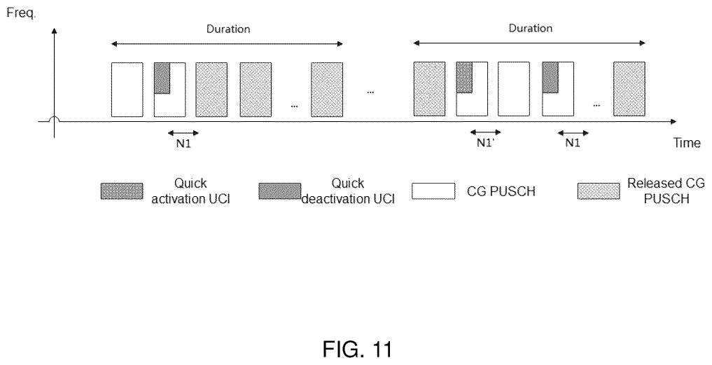

FIG. 11 shows that when control signaling is UCI for activation or release of CG PUSCHs in the CG PUSCH group, in one example, the application delay includes:
The starting time point: a slot of the first activated/released CG PUSCH in the CG PUSCH group.
The ending time point: a slot of UCI transmission (or, the starting time point is a slot of UCI transmission, while the ending time point is a slot of the first activated/released CG PUSCH in the CG PUSCH group)
A distance: N₁ slots
Assuming the slot of the first activated/released CG PUSCH in the CG PUSCH group is at the n-slot, the slot of the UCI signaling for activation or release CG PUSCHs in the CG PUSCH group is at or before,

$$⌊ n \times \frac{{2}^{u , P D S C H}}{{2}^{u , PDCCH}} ⌋ - {N}_{1} or n - {N}_{1}$$

where n denotes the slot for PDCCH monitoring, u denotes the subcarrier spacing (SCS).
In another example, the application delay includes:
The starting time point: a first symbol of the first activated/released CG PUSCH in the CG PUSCH group.
The ending time point: a last symbol of UCI transmission (or, the starting time point is a last symbol of UCI transmission, while the ending time point is a first symbol of the first activated/released CG PUSCH in the CG PUSCH group)
A distance: N₁ symbols
Assuming the symbol of the first activated/released CG PUSCH in the CG PUSCH group is at the n-th symbol, the last symbol of the UCI signaling for activation or release CG PUSCHs in the CG PUSCH group is at or before,

$$⌊ {n}_{slot} \times \frac{{2}^{u , PDSCH}}{{2}^{u , PDCCH}} \times {N}_{slot}^{s y m b o l} ⌋ + n - {N}_{1} or {n}_{slot} \times {N}_{slot}^{symbol} + n - {N}_{1}$$

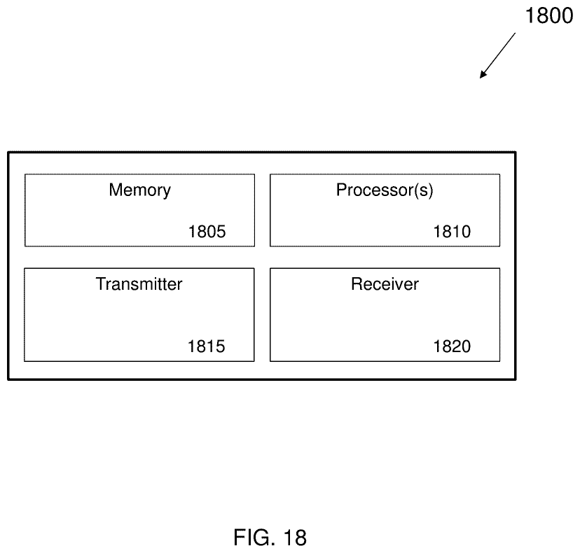

FIG. 18 shows an exemplary block diagram of a hardware platform 1800 that may be a part of a network device (e.g., base station) or a communication device (e.g., a user equipment (UE)). The hardware platform 1800 includes at least one processor 1810 and a memory 1805 having instructions stored thereupon. The instructions upon execution by the processor 1810 configure the hardware platform 1800 to perform the operations described in FIGS. 1 to 17 and 19 to 23, and in the various embodiments described in this patent document. The transmitter 1815 transmits or sends information or data to another device. For example, a network device transmitter can send a message to a user equipment. The receiver 1820 receives information or data transmitted or sent by another device. For example, a user equipment can receive a message from a network device.

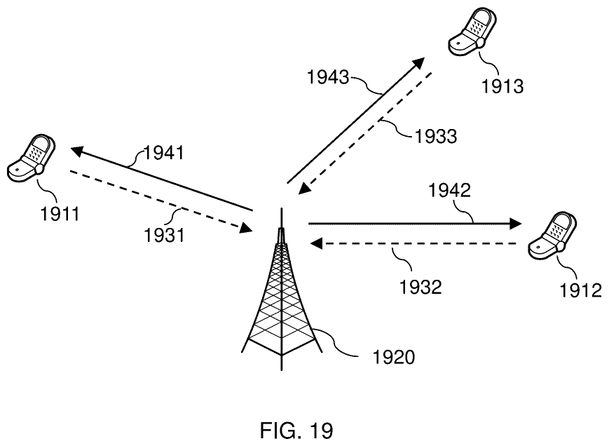

The implementations as discussed above will apply to a wireless communication. FIG. 19 shows an example of a wireless communication system (e.g., a 5G or NR cellular network) that includes a base station 1920 and one or more user equipment (UE) 1911, 1912 and 1913. In some embodiments, the UEs access the BS (e.g., the network) using a communication link to the network (sometimes called uplink direction, as depicted by dashed arrows 1931, 1932, 1933), which then enables subsequent communication (e.g., shown in the direction from the network to the UEs, sometimes called downlink direction, shown by arrows 1941, 1942, 1943) from the BS to the UEs. In some embodiments, the BS send information to the UEs (sometimes called downlink direction, as depicted by arrows 1941, 1942, 1943), which then enables subsequent communication (e.g., shown in the direction from the UEs to the BS, sometimes called uplink direction, shown by dashed arrows 1931, 1932, 1933) from the UEs to the BS. The UE may be, for example, a smartphone, a tablet, a mobile computer, a machine to machine (M2M) device, an Internet of Things (IoT) device, and so on.

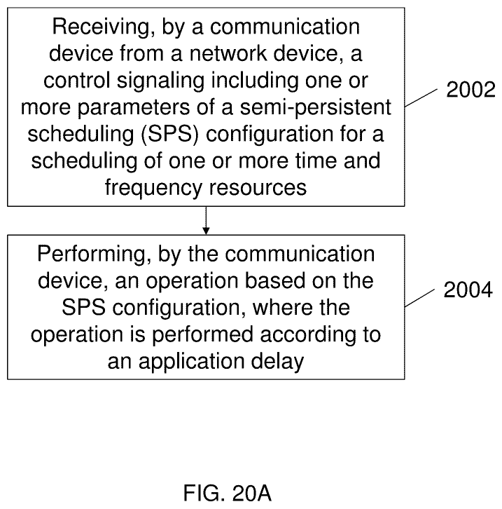

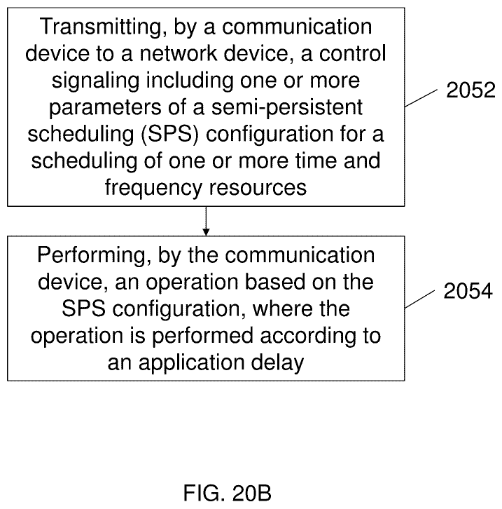

FIG. 20A shows an exemplary flowchart for receiving a control signaling and performing an operation. Operation 2002 includes receiving, by a communication device from a network device, a control signaling including one or more parameters of a semi-persistent scheduling (SPS) configuration for a scheduling of one or more time and frequency resources. Operation 2004 includes performing, by the communication device, an operation based on the SPS configuration, where the operation is performed according to an application delay.

FIG. 20A shows an exemplary flowchart for transmitting a control signaling and performing an operation. Operation 2052 includes transmitting, by a communication device to a network device, a control signaling including one or more parameters of a semi-persistent scheduling (SPS) configuration for a scheduling of one or more time and frequency resources. Operation 2054 includes performing, by the communication device, an operation based on the SPS configuration, where the operation is performed according to an application delay.

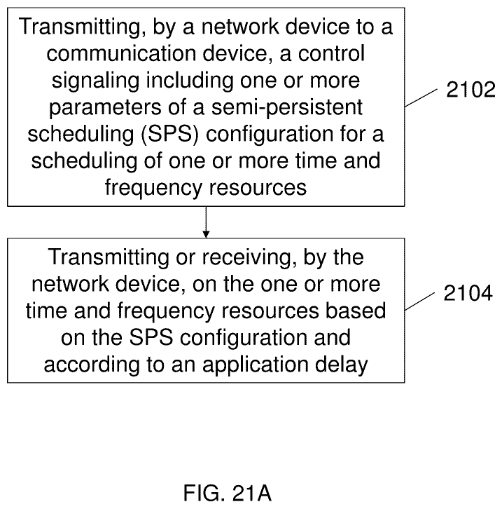

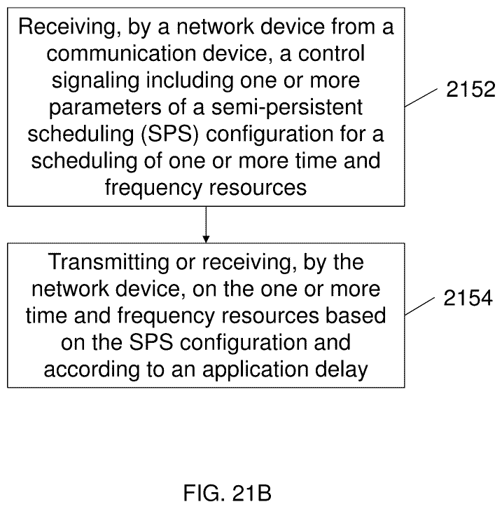

FIG. 21A shows an exemplary flowchart for transmitting or receiving on one or more time and frequency resources. Operation 2102 includes transmitting, by a network device to a communication device, a control signaling including one or more parameters of a semi-persistent scheduling (SPS) configuration for a scheduling of one or more time and frequency resources. Operation 2104 includes transmitting or receiving, by the network device, on the one or more time and frequency resources based on the SPS configuration and according to an application delay.

FIG. 21B shows another exemplary flowchart for transmitting or receiving on one or more time and frequency resources. Operation 2152 includes receiving, by a network device from a communication device, a control signaling including one or more parameters of a semi-persistent scheduling (SPS) configuration for a scheduling of one or more time and frequency resources. Operation 2154 includes transmitting or receiving, by the network device, on the one or more time and frequency resources based on the SPS configuration and according to an application delay.

The following exemplary operations and features are applicable to the method in FIGS. 20A, 20B, 21A, and 21B.

In some embodiments, the SPS configuration includes any one or more of: a periodicity information, one or more SPS configuration indices, one or more time and frequency resources, one or more time and frequency resource groups, a length information of a duration, a valid or invalid indication, and/or an offset information. In some embodiments, each of the one or more time and frequency resource groups include a set of time and frequency resources, the set of one or more time and frequency resources are associated with a length information of a duration and a valid or invalid indication, the length information of the duration indicates a time range for the set of one or more time and frequency resources, and the valid or invalid indication indicates a time domain location of the set of one or more time and frequency resources. In some embodiments, each of the one or more time and frequency resources group is associated with a plurality of SPS configuration indices and an offset information, and the offset information indicates an offset between a set of one or more time and frequency resources with different SPS configuration indices.

In some embodiments, the control signaling includes any one or more of: Radio Resource Control (RRC) signaling, Medium Access Control Control Element (MAC CE) signaling, Downlink Control Information (DCI) signaling, or Uplink Control information (UCI) signaling. In some embodiments, the one or more parameters of the SPS configuration in the DCI signaling includes one or more types of indications that includes: an activation indication for the one or more time and frequency resources, a release indication for the one or more time and frequency resources, and/or an update indication and updated parameters for the one or more time and frequency resources. In some embodiments, the one or more parameters of the SPS configuration in DCI signaling includes an activation indication that indicates that at least one time and frequency resource is used for transmitting or receiving data. In some embodiments, the one or more parameters of the SPS configuration in DCI signaling includes a release indication that indicates that at least one time and frequency resource is not used for transmitting or receiving data.

In some embodiments, the one or more parameters of the SPS configuration in DCI signaling includes an update indication that indicates that at least one parameter of the SPS configuration is updated by information included in the control signaling. In some embodiments, the updated parameters of the SPS configuration includes any one or more of: a Modulation and Coding Scheme (MCS) level, an information for MCS table, a time domain resource assignment (TDRA), a frequency domain resource assignment (FDRA), a number of layers, a periodicity information, a valid or invalid indication, and/or an offset information. In some embodiments, the one or more types of indication is determined or indicated by any one or more of: high layer parameters, a DCI format, a DCI field including, a HARQ Process Number, a Redundancy Version, a Time domain resource assignment, a Frequency domain resource assignment, a MCS, a Downlink assignment index, a TPC command for scheduled PUCCH, and/or a VRB-to-PRB mapping.

In some embodiments, the one or more parameters of the SPS configuration in the UCI signaling includes any one or more of: an activation indication for the one or more time and frequency resources, and/or a release indication for the one or more time and frequency resources. In some embodiments, the one or more parameters of the SPS configuration in UCI signaling includes the activation indication that indicates that at least one time and frequency resource is used for transmitting or receiving data. In some embodiments, the one or more parameters of the SPS configuration in UCI signaling includes the release indication that indicates that at least one time and frequency resource is not used for transmitting or receiving data. In some embodiments, the operation based on SPS configuration includes any one of: transmitting in the one or more time and frequency resources, receiving in the one or more time and frequency domain resources, determining not to transmit in the one or more time and frequency resources, or determining not to receive in one or more time and frequency domain resources. In some embodiments, the application delay is determined by any one or more of: a starting time point; an ending time point; a distance between the starting time point and the ending time point.

In some embodiments, the starting time point includes at least one of the following: a slot of Physical Downlink Control Channel (PDCCH) monitoring; a last symbol of PDCCH monitoring; a slot for UCI transmission; a last symbol of Physical Uplink Control Channel (PUCCH) transmitting UCI; a last symbol of Physical Uplink Shared Channel (PUSCH) transmitting UCI; a slot of the first resource in the one or more time and frequency resources; a first symbol of the one or more time and frequency resources; a last symbol of one or more time and frequency resource. In some embodiments, the ending time point includes at least one of the following: a slot of the one or more time and frequency resources; a last symbol of the one or more time and frequency resources; a slot of UCI transmission; a first symbol of PUCCH transmitting UCI; a first symbol of PUSCH transmitting UCI, a slot of PDCCH monitoring; a first symbol of PDCCH monitoring. In some embodiments, the slot of the one or more time and frequency resources includes a slot of the first resource within the one or more time and frequency resource, a slot of the first resource within the time and frequency resource group, a slot of the last resource within the one or more time and frequency resources, or a slot of the last resource within the time and frequency resource group.

In some embodiments, the first or last symbol of the one or more time and frequency resources includes the first or last symbol of the first resource within the one or more time and frequency resources, the first or last symbol of the first resource within the time and frequency resource group, the first or last symbols of the last resource within the one or more time and frequency resources, the first or last symbols of the last resource within the time and frequency resource group. In some embodiments, a distance K between the starting time point and the ending time point is determined or indicated by at least one of: a high layer parameter; a subcarrier spacing; a User Equipment (UE) capability, where the distance K is a positive integer in symbol, slot or millisecond. In some embodiments, in the distance K, any one or more of the following operations is performed: another control signaling is not transmitted in the distance K; another control signaling are not transmitted in the same slot of the control signaling; another control signaling are expired when they are transmitted in the distance K; or another control signaling replace the control signaling when they are transmitted in the distance K. In some embodiments, the application delay includes the slot or the last symbol of PDCCH monitoring as the starting time point, the slot or the first symbol of the first resource within the time and frequency resource group as the ending time point and distance K slots or symbols between the slot or the last symbol of PDCCH monitoring and the slot or the first symbol of the first resource, when the control signaling is received in an n−th slot or symbol, the operation is performed at the slot of the first resource within the time and frequency resource group located at an (n+K)-th slot or symbol, and where n and K are integers greater than or equal to one.

In some embodiments, the application delay includes the slot or the last symbol of PDCCH monitoring as the starting time point, the slot or the first symbol of the PDCCH monitoring or the UCI transmission as the ending time point, and distance K slots or symbols between the slot or the last symbols of PDCCH monitoring and the slot or the first symbol of PDCCH monitoring or the UCI transmission, when the control signaling is received in an n-th slot or symbol, the operation is performed at the time and frequency resource located at an (n+K)-th slot or symbol in response to the communication device by DCI or UCI, and where n and K are integers greater than or equal to one. In some embodiments, the application delay includes the slot or the first symbol of the PDCCH monitoring or the UCI transmission as the starting time point, the slot or the last symbol of PDCCH monitoring as the starting time point, and distance K slots or symbols between the slot or the first symbol of PDCCH monitoring or the UCI transmission and the slot or the last symbols of PDCCH monitoring, when the operation is performed at the time and frequency resource located at an n-th slot or symbol in response to the communication device by DCI or UCI, the control signaling is received in an (n−K)-th slot or symbol, or before an (n−K)-th slot or symbol, where n and K are integers greater than or equal to one, and where K is less than n.

In some embodiments, the application delay includes the slot or the first symbol of the first resource within the time and frequency domain resource group as the starting time point, the slot or the last symbol of PDCCH monitoring as the ending time point, and the distance K slots or symbols between the slot or the first symbol of the first resource and the slot or the last symbol of PDCCH monitoring, when the operation is performed at the first resource within the time and frequency resource group located at an n-slot or symbol, the control signaling is received in an (n−K)-th slot or symbol, or before an (n−K)-th slot or symbol and where n and K are integers greater than or equal to one. In some embodiments, the application delay includes the slot or the first symbol of the UCI transmission as the starting time point, the slot or the first symbol of the first resource within the time and frequency resource group as the ending time point, and the distance K slots or symbols between the slot or the first symbol of the UCI transmission and the slot or the last symbol of the first resource, when the control signaling is transmitting in an n-th slot or symbol, the operation is performed at the time and frequency resource located within the time ranging from (n−K)-th slot or symbol to (n)-th slot or symbol and where n and K are integers greater than or equal to one. In some embodiments, the SPS includes a configured grant (CG).

In this document the term “exemplary” is used to mean “an example of” and, unless otherwise stated, does not imply an ideal or a preferred embodiment.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this disclosure.

What is claimed is:

1. A wireless communication method, comprising:
receiving, by a communication device from a network device, a control signaling including one or more parameters of a semi-persistent scheduling (SPS) configuration for a scheduling of one or more time and frequency resources; and
performing, by the communication device, an operation based on the SPS configuration, wherein the operation is performed according to an application delay.

2. The method of claim 1, wherein the SPS configuration includes:
one or more time and frequency resources,
one or more time and frequency resource groups,
a length information of a duration,
a valid or invalid indication, and
an offset information.

3. The method of claim 2,
wherein each of the one or more time and frequency resource groups include a set of time and frequency resources,
wherein the set of one or more time and frequency resources are associated with a length information of a duration and a valid or invalid indication,
wherein the length information of the duration indicates a time range for the set of one or more time and frequency resources, and
wherein the valid or invalid indication indicates a time domain location of the set of one or more time and frequency resources.

4. The method of claim 2,
wherein each of the one or more time and frequency resource group is associated with a plurality of SPS configuration indices and the offset information, and
wherein the offset information indicates an offset between a set of one or more time and frequency resources with different SPS configuration indices.

5. The method of claim 1, wherein the control signaling includes Downlink Control Information (DCI) signaling.

6. The method of claim 5, wherein the one or more parameters of the SPS configuration in the DCI signaling includes one or more types of indications that includes:
an activation indication for the one or more time and frequency resources,
a release indication for the one or more time and frequency resources, and/or
an update indication and updated parameters for the one or more time and frequency resources.

7. The method of claim 6, wherein the one or more parameters of the SPS configuration in DCI signaling includes an activation indication that indicates that at least one time and frequency resource is used for transmitting or receiving data.

8. The method of claim 6, wherein the one or more parameters of the SPS configuration in DCI signaling includes a release indication that indicates that at least one time and frequency resource is not used for transmitting or receiving data.

9. The method of claim 6, wherein the one or more parameters of the SPS configuration in DCI signaling includes an update indication that indicates that at least one parameter of the SPS configuration is updated by information included in the control signaling.

10. The method of claim 1, wherein the operation based on SPS configuration includes any one of:
transmitting in the one or more time and frequency resources,
receiving in the one or more time and frequency resources,
determining not to transmit in the one or more time and frequency resources, or
determining not to receive in one or more time and frequency domain resources.

11. The method of claim 1, wherein the application delay is determined by a distance between a starting time point and an ending time point.

12. The method of claim 11, wherein a distance K between the starting time point and the ending time point is determined or indicated by a subcarrier spacing, wherein the distance K is a positive integer in symbol.

13. The method of claim 12, wherein in the distance K, another control signaling is not transmitted in the distance K.

14. An apparatus for wireless communication comprising one or more processors, wherein the one or more processors are configured to cause the apparatus to:
receive, by a communication device from a network device, a control signaling including one or more parameters of a semi-persistent scheduling (SPS) configuration for a scheduling of one or more time and frequency resources; and
perform, by the communication device, an operation based on the SPS configuration, wherein the operation is performed according to an application delay.

15. The apparatus of claim 14, wherein the SPS configuration includes:
one or more time and frequency resources,
one or more time and frequency resource groups,
a length information of a duration,
a valid or invalid indication, and
an offset information.

16. The apparatus of claim 15,
wherein each of the one or more time and frequency resource groups include a set of time and frequency resources,
wherein the set of one or more time and frequency resources are associated with a length information of a duration and a valid or invalid indication,
wherein the length information of the duration indicates a time range for the set of one or more time and frequency resources, and
wherein the valid or invalid indication indicates a time domain location of the set of one or more time and frequency resources.

17. The apparatus of claim 15,
wherein each of the one or more time and frequency resource group is associated with a plurality of SPS configuration indices and the offset information, and
wherein the offset information indicates an offset between a set of one or more time and frequency resources with different SPS configuration indices.

18. The apparatus of claim 14, wherein the control signaling includes Downlink Control Information (DCI) signaling.

19. The apparatus of claim 18, wherein the one or more parameters of the SPS configuration in the DCI signaling includes one or more types of indications that includes:
an activation indication for the one or more time and frequency resources,
a release indication for the one or more time and frequency resources, and/or
an update indication and updated parameters for the one or more time and frequency resources.

20. The apparatus of claim 19, wherein the one or more parameters of the SPS configuration in DCI signaling includes an activation indication that indicates that at least one time and frequency resource is used for transmitting or receiving data.
